(19) United States
(12) Patent Application Publication
(10) Pub. No.: US 2013/0181063 A1
(43) Pub. Date: Jul. 18, 2013

(54) Liquid Atomizing Device and Liquid Atomizing Method

(71) Applicants: Hiroyoshi Asakawa, Hyogo (JP); Ryota Kuge, Hyogo (JP)

(72) Inventors: Hiroyoshi Asakawa, Hyogo (JP); Ryota Kuge, Hyogo (JP)

(73) Assignee: Nozzle Network Co., Ltd, Tamba-shi, Hyogo (JP)

(21) Appl. No.: 13/824,933

(22) PCT Filed: Sep. 15, 2011
(86) PCT No.: PCT/JP2011/071119

§ 371 Date: Mar. 18, 2013

(30) Foreign Application Priority Data
Sep. 21, 2010 (JP) 2010211115

(51) Int. Cl. B05B 7/08

(52) U.S. Cl. CPC B05B 7/0815
USPC 239/8; 239/422

(57) ABSTRACT

A liquid atomizing method in which a collision portion formed by making at least two gases collide with each other, or a portion including the collision portion, and liquid are made to collide with each other to atomize the liquid. A liquid atomizing device includes at least two gas injection portions from which gases are injected, and a liquid injection portion from which liquid is injected, a collision portion formed by making gases injected from the at least two gas injection portions collide with each other or a portion including the collision portion, and liquid injected from the liquid injection portion are made to collide with each other to atomize the liquid.

### TECHNICAL FIELD

The present invention relates to a liquid atomizing device and a liquid atomizing method for atomizing liquid.

### BACKGROUND ART

As conventional atomizing technique, there are a gas-liquid mix type (two-fluid type) technique, an ultrasound type technique, an extra-high voltage type (100 MPa to 300 MPa) technique, and a steaming type technique. According to a general two-fluid nozzle, gas and liquid are injected in the same injection direction, and liquid is miniaturized by a shear effect generated by accompanying flow of gas and liquid.

As one example of a gas-liquid mix type two-fluid nozzle, an atomizing nozzle device for producing minute particle mist is known (patent document 1). This atomizing nozzle device includes a first nozzle portion and a second nozzle portion, atomized liquid from the first nozzle portion and atomized liquid from the second nozzle portion are made to collide with each other, and minute particle mist can be formed. However, since the atomizing nozzle device includes two two-fluid nozzle portions, the atomizing nozzle device becomes expensive and this is not suitable for miniaturization.

### PRIOR ART DOCUMENTS

### Patent Documents

Patent Document 1: JP-A-2002-126587

### SUMMARY OF THE INVENTION

### Problems to be Solved by the Invention

It is an object of the present invention to provide a liquid atomizing device and a liquid atomizing method capable of atomizing liquid with a simple device configuration using a new principle which is different from the miniaturization principle of the above-described prior art.

### Means for Solving the Problems

A liquid atomizing device of the present invention includes at least two gas injection portions from which gases are injected, and a liquid injection portion from which liquid is injected, a collision portion formed by making gases injected from the at least two gas injection portions collide with each other or a portion including the collision portion, and liquid injected from the liquid injection portion are made to collide with each other to atomize the liquid.

An operation effect of this configuration will be described with reference to FIG. 1. Gases 11, 21 injected from at least two gas injection portions 1, 2 are made to collide with each other to form a collision portion 100. A portion including this collision portion 100 is defined as a collision wall 101 (FIG. 1(a)). Liquid 61 injected from a liquid injection portion 6 collides with the collision portion 100 or the collision wall 101 (FIG. 1(b)). If the liquid 61 collides with the collision portion 100 or the collision wall 101, the liquid 61 is crushed (atomized) and becomes an atomized body 62. Gases injected from at least the two gas injection portions are made to collide with the liquid injected from liquid injecting means. According to this configuration, the collision portion or the collision wall formed by the injected liquid and gases can collide with each other. According to this collision, the liquid can be atomized.

According to the liquid atomizing device of the invention, liquid and the collision portion or the collision wall of the gases are made to collide with each other and pulverized. According to this collision, it is possible to efficiently atomize under a low pressure (low gas pressure, low liquid pressure) at low flow rate (low gas flow rate, low liquid flow rate) with low energy and efficiently. As compared with the conventional two-fluid nozzle, it is possible to atomize with low gas-liquid volume ratio (or gas-liquid ratio). As compared with the conventional two-fluid nozzle, the liquid atomizing device of the invention has lower noise. A structure of the liquid atomizing device of the invention can be simplified.

Although a pressure and a flow rate of gas injected from the gas injection portion are not especially limited, it is possible to suitably atomize liquid under a low gas pressure at a low gas flow rate by the atomizing principle of the invention. It is preferable that pressures of gases which configure the collision portion and the collision wall are set equal to or substantially equal to each other, and it is preferable that flow rates of gases configuring the collision portion and the collision wall are set equal to or substantially equal to each other. A cross sectional shape of gas injected from the gas injection portion is not especially limited, and it is possible to employ a circular shape, an oval shape, a rectangular shape and a polygonal shape. It is preferable that cross sectional shapes of gases which configure the collision portion and the collision wall are equal to or substantially equal to each other. It is preferable that a collision portion having a constant shape and a constant size is maintained by suppressing deformation and size reduction of the collision portion, so that an atomized body having a stable atomizing amount and small change in particle diameter is produced.

Although a pressure and a flow rate of liquid injected from the liquid injection portion are not especially limited, it is possible to suitably atomize liquid having a low pressure and a low flow rate by the atomizing principle of the invention. A pressure of the liquid injection portion may be a water pressure in a general water pipe, and the liquid injection portion may be a device which makes liquid drop naturally. In this invention, concerning an expression “liquid injected by the liquid injection portion”, liquid which drops at a natural dropping speed is included in the “injected liquid”.

When injected liquid and the collision portion or the collision wall of the gases are made to collide with each other, it is preferable that a collision cross-sectional area of liquid is smaller than the collision portion or the collision wall. If an injection cross section of injected liquid is greater than the collision portion or the collision wall of gases, a portion of liquid does not collide with the collision portion or the collision wall and is not atomized and this is not preferable. When it is desired to atomize a portion of liquid as one example of an embodiment, an injection cross section of liquid may be set greater than the collision portion or the collision wall of gases, or a relative disposition of the liquid injection portion and the gas injection portion may be set such that a portion of injected liquid collides with the collision portion or the collision wall.

It is preferable that an orifice diameter of the liquid injection portion is smaller than an orifice diameter of the gas injection portion. According to this configuration, a collision cross-sectional area of liquid can be made smaller than the collision wall of gas.

An example of the relative disposition of the liquid injection portion and the gas injection portion will be described with reference to FIG. 3. A gas-liquid collision position is determined by this relative disposition. According to a disposition shown in FIG. 3(a), the gas injection portions 1, 2 are opposed to each other, and a tip end of a nozzle of the liquid injection portion 6 is in contact with outer surface portions of tip ends of both the nozzles of the gas injection portions 1, 2. According to a disposition (b), the gas injection portions 1, 2 are opposed to each other, and the tip ends of both the nozzles of the gas injection portions 1, 2 are in contact with the tip end of the nozzle of the liquid injection portion 6. According to the disposition (b), a flow rate of injected liquid is greater than that of the disposition (a), and there is a tendency that backflow is smaller than that of the disposition (a). According to a disposition (c), the nozzle of the liquid injection portion 6 enters between the tip ends of both the nozzles of the gas injection portions 1, 2. According to a disposition (d), a distance between both the nozzles of the gas injection portions 1, 2 is greater than that of the disposition (b). According to a disposition (e), the liquid injection portion 6 is located far from the collision wall as compared with the disposition (b). In FIG. 3, two gas injection portions are disposed, but the number of gas injection portions is not limited to two, and the number may be three, four or more (see FIG. 2B). Although one liquid injection portion is shown, the number of liquid injection portions may be two. In FIG. 3(f), two liquid injection portions are disposed.

The atomized body is atomized together with discharged gas flow which is discharged from the collision portion of gas. The discharged gas flow forms an atomization pattern. As the atomization pattern, when liquid and a collision portion formed by collision of two injected gases collide with each other for example, the atomization pattern is formed into a wide fan-shape in the same direction as a liquid injection direction, and a cross section shape thereof is an oval shape or a long circular shape (see FIGS. 2A(a) and (b)). When four gases are injected from four directions arranged at 90° intervals from one another and a collision portion is formed at one location, an atomization pattern is formed into a cone shape or a columnar shape in the same direction as a liquid injection direction, and a cross section shape is substantially a circular shape (see FIGS. 2B(a) and (b)).

As one embodiment of the invention, it is preferable that an injection direction axis of a first gas injection portion and an injection direction axis of a second gas injection portion form a predetermined angle range. The “predetermined angle range” formed by the injection direction axes of the first gas injection portion 1 and the second gas injection portion 2 corresponds to a collision angle between gas injected from the first gas injection portion 1 and gas injected from the second gas injection portion 2, and the “predetermined angle range (collision angle)” is in a range of 10° to 350°, preferably in a range of 45° to 220°, more preferably in a range of 130° to 200°, and more preferably in a range of 140° to 190°. FIG. 4 shows a collision angle α. When liquid is injected to a collision portion which forms a collision angle smaller than 180°, as the collision angle is smaller, it resembles a conventional two-fluid nozzle principle (gas and liquid are injected in the same injection direction and liquid is miniaturized by a shear effect generated by accompanying flow of gas and liquid). Therefore, there is a tendency that the effect of the miniaturization principle of the invention becomes low, but as the collision angle is smaller, there is a tendency that backflow of injected liquid is suppressed. When liquid is injected to a collision portion which forms a collision angle greater than 180°, as the collision angle is greater, there is a tendency that injected gas and gas which collides and widens function to push back injected liquid to make the liquid flow backward. In FIG. 4, a tip end of the nozzle of the liquid injection portion 6 is in contact with tip ends of both the nozzles of the gas injection portions 1, 2, but the invention is not limited to this configuration. A position of the tip end of the nozzle of the liquid injection portion 6 may be disposed between both the nozzles of the gas injection portions 1, 2 or may be separated away from the gas injection portions 1, 2 as compared with the disposition shown in FIG. 4.

As one embodiment of the invention, it is preferable that an injection direction of the first gas injection portion and an injection direction of the second gas injection portion are opposed to each other (are opposite from each other), and an injection direction axis of the first gas injection portion and an injection direction axis of the second gas injection portion match with each other. This means that a collision angle α of gas injected from the first gas injection portion and gas injected from the second gas injection portion is 180°, and the injection direction axes match with each other.

As one embodiment of the invention, it is preferable that the liquid injection portion injects liquid such that the injection direction axis of liquid intersects with the collision portion at right angles. FIG. 1(b) shows an example in which the injection direction axis of liquid intersects with the collision portion 100 and the collision wall 101 at right angles. As another embodiment, FIG. 5 shows an example in which the injection direction axis of liquid is inclined with respect to the collision portion 100 and the collision wall 101. This inclination angle β is in a range of ±80° from 0° (intersection position), preferably in a range of ±45° from 0°, more preferably in a range of 30° from 0°, and more preferably in a range of ±15° from 0°. As the inclination angle β becomes smaller, there is a tendency that producing efficiency of atomized body is higher.

As one embodiment of the invention, the liquid atomizing device further includes an auxiliary gas injection portion which is disposed at a level different from the gas injection portion, and the auxiliary gas injection portion is disposed toward the liquid injection direction from the liquid injection portion. According to this configuration, in an atomized body obtained by making liquid collide with a collision portion or a portion (collision wall) including the collision portion, when a droplet (minute particle having rough particle diameter) is generated due to an orifice diameter of each injection portion or an injection pressure condition, or due to a fact that an atomization pattern spreads too wide angle and it comes into contact with an injection outlet, first and second auxiliary gases can suitably suppress the generation of droplet.

As one embodiment of the invention, it is preferable that the liquid is of continuous flow, intermittent flow or impulse flow. The continuous flow is columnar liquid flow. The intermittent flow is liquid flow injecting at predetermined intervals. The impulse flow is liquid flow injecting instantaneously at predetermined timing. By controlling an injection method of liquid at will by a liquid supply device or the like, it is possible to control atomizing timing and an atomizing amount of an atomized body at will.

As one embodiment of the invention, the liquid is miniaturized liquid. As liquid injected from the liquid injection portion, it is possible to use miniaturized liquid minute particle, and an example of the liquid minute particle is liquid minute particle which is miniaturized by a two-fluid nozzle device, an ultrasound device, an extra-high voltage atomizer, a steaming type atomizer and the like.

As one embodiment of the invention, the liquid atomizing device further includes a restricting gas injection portion which injects gas for deforming a pattern shape of an atomization pattern of an atomized body formed by atomizing liquid by making a portion including the collision portion and liquid injected by the liquid injection portion collide with each other. According to this configuration, it is possible to deform a pattern shape of an atomization pattern at will. By deforming a wide angle atomization pattern to form a small angle atomization pattern, it is possible to suppress a case where an atomized body comes into contact with nozzle portions of the gas injection portion and liquid injection portion and the atomized body grows up into liquid drop. It is preferable that an injection amount and/or an injection speed of gas injected from the restricting gas injection portion are set smaller than an injection amount and/or an injection speed of gas injected from the gas injection portion.

For example, when the atomization pattern of an atomized body which is atomized by making liquid injected by the liquid injection portion collide with a portion including a collision portion formed by the first gas injection portion and the second gas injection portion disposed such that their injection directions are opposed to each other has wide angle and its pattern cross section is an oval shape or a long circular shape, gas is injected from the restricting gas injection portion toward a portion including a collision portion of gas or toward a generated atomized body such that the angle of the atomization pattern becomes small. According to this configuration, it is possible to deform (restrict) the atomization pattern. Gas orifice cross-sectional areas of restricting gas injection portions 71 and 72 shown in FIG. 6 are made smaller than gas orifice cross-sectional areas of the gas injection portions 1, 2, and an angle of an atomization pattern of the atomized body 62 is adjusted. As shown in FIG. 6, the restricting gas injection portions 71 and 72 are disposed at right angles with respect to the gas injection portions 1, 2, but the invention is not especially limited to this disposition. Gases injected from the restricting gas injection portion collide with the collision wall including the collision portion of gas at right angles, but the invention is not especially limited to this configuration, and the restricting gas injection portions may incline as shown in FIG. 6(c).

According to another aspect of the invention, there is provided a liquid atomizing method in which a collision portion formed by making at least two gases collide with each other, or a portion including the collision portion, and liquid are made to collide with each other to atomize the liquid. By making the collision portion or the collision wall of gases and liquid collide with each other and collide and pulverize, it is possible to atomize under a low pressure (low gas pressure, low liquid pressure) at low flow rate (low gas flow rate, low liquid flow rate) with low energy and efficiently, and it is possible to atomize at a low gas liquid ratio.

The gas is not especially limited, but examples of the gas are air, clean air, nitrogen, inert gas, fuel mixture air and oxygen, and it is possible to appropriately set gas in accordance with intended use.

The liquid is not especially limited, but examples of the liquid are water, ionized water, cosmetic medicinal solution such as skin lotion, medicinal solution, bactericidal solution, medicinal solution such as sterilization solution, paint, fuel oil, coating agent, solvent and resin.

### BRIEF DESCRIPTION OF THE DRAWINGS

FIG. 1 are schematic diagrams for describing one example of a liquid atomizing device;

FIG. 2A are schematic diagrams for describing one example of the liquid atomizing device, wherein FIG. 2A(a) is a diagram as viewed from above, and (b) is a diagram as viewed from side;

FIG. 2B are schematic diagrams for describing one example of the liquid atomizing device, wherein FIG. 2B(a) is a diagram as viewed from above, and (b) is a diagram as viewed from side;

FIG. 3 are schematic diagrams for describing one example of the liquid atomizing device;

FIG. 4 is a schematic diagram for describing one example of the liquid atomizing device;

FIG. 5 is a schematic diagram for describing one example of the liquid atomizing device;

FIG. 6 are schematic diagrams for describing one example of the liquid atomizing device, wherein FIG. 6B(a) is a diagram as viewed from above, and (b) and (c) are diagrams as viewed from side;

FIG. 7 are schematic diagrams for describing one example of the liquid atomizing device;

FIG. 8 are schematic diagrams for describing one example of the liquid atomizing device;

FIG. 9 are schematic diagrams for describing one example of the liquid atomizing device;

FIG. 10 is a diagram showing an example of a relation between a water pressure and an atomizing amount;

FIG. 11 is a diagram showing an example of a relation between an atomizing amount and an average particle diameter;

FIG. 12 is a diagram showing an example of a relation between an atomizing distance and the average particle diameter;

FIG. 13 is a diagram showing an example of a relation between the atomizing distance and a flow speed;

FIG. 14 is a diagram showing a pressure and atomizing amount characteristics;

FIG. 15 are schematic diagrams for describing one example of the liquid atomizing device; and

FIG. 16 is a schematic diagram for describing one example of the liquid atomizing device.

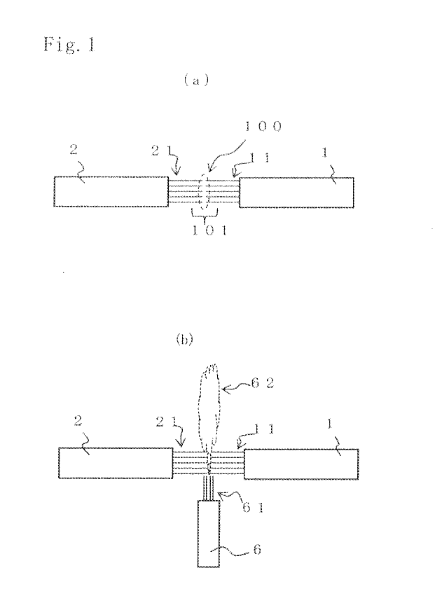

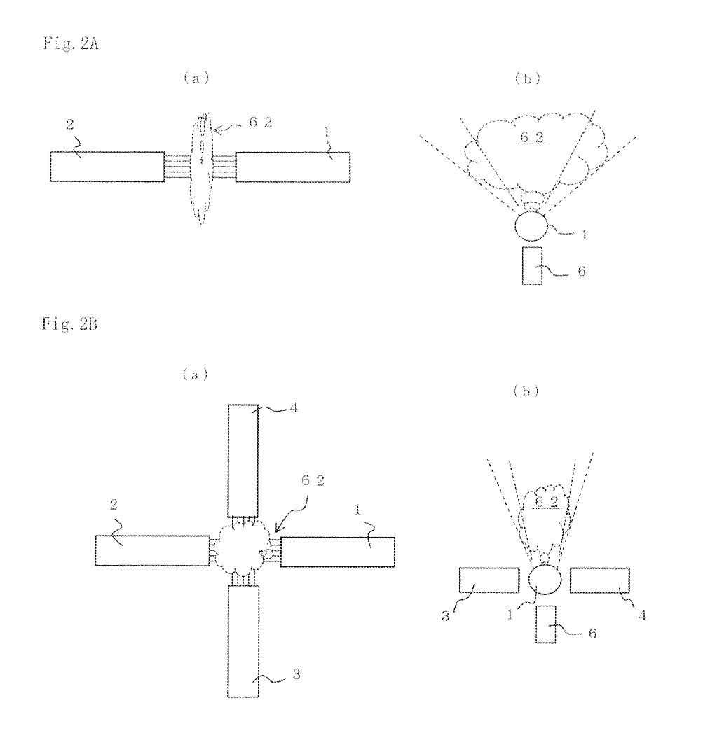

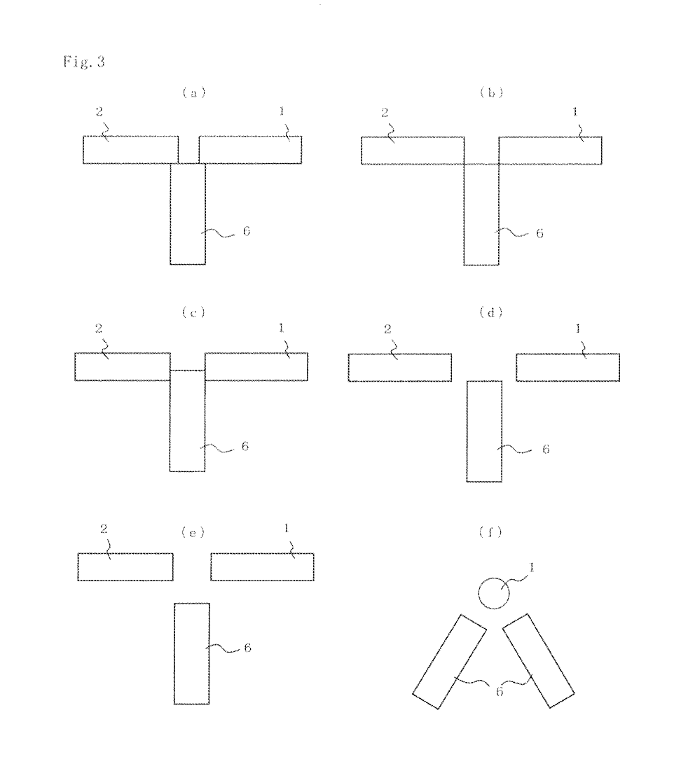

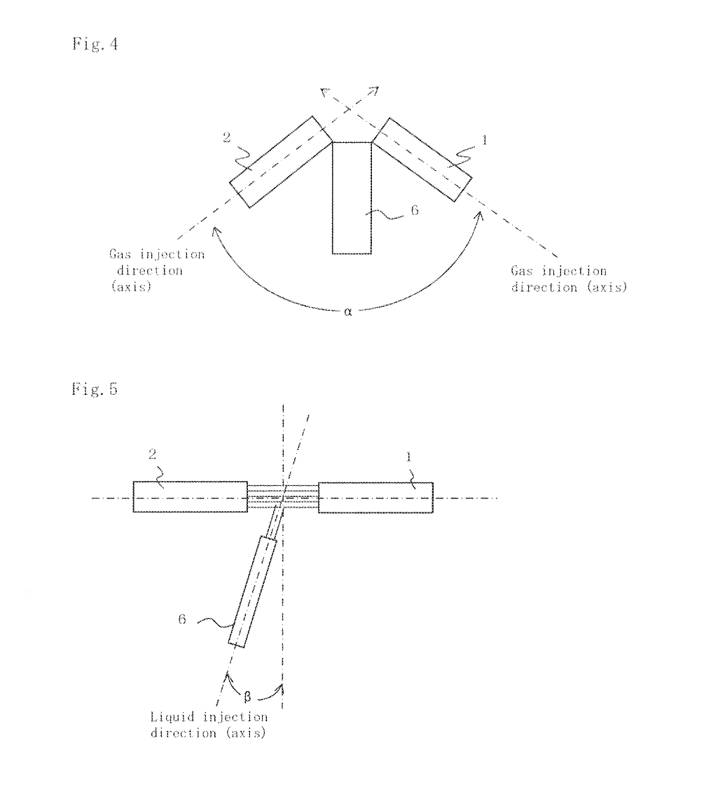

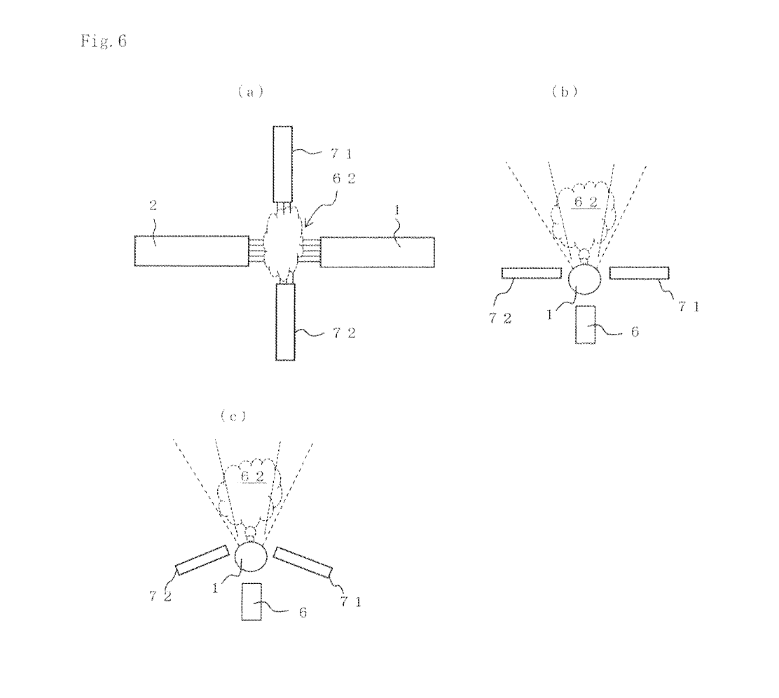

### MODE FOR CARRYING OUT THE INVENTION

### Embodiment 1

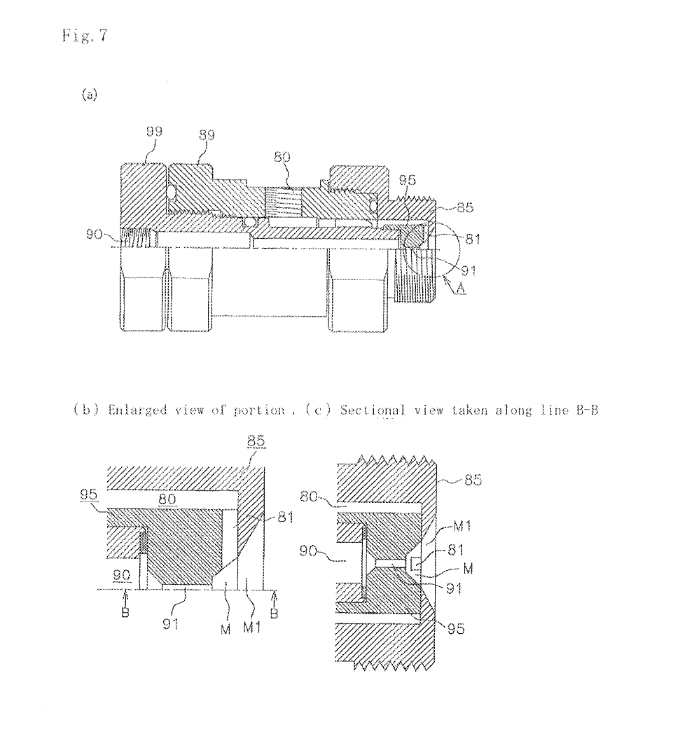

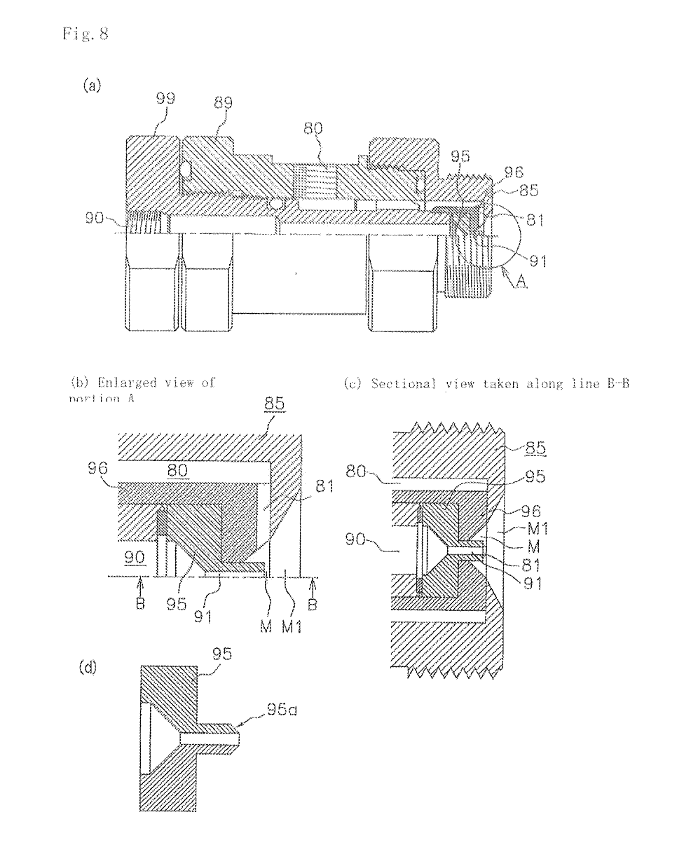

A liquid atomizing device of the embodiment will be described with reference to FIG. 7. The liquid atomizing device shown in FIG. 7 is configured as a nozzle device. A first gas orifice 81 configuring a first gas injection portion and a second gas orifice (not shown) configuring a second gas injection portion are disposed such that the gas orifices are opposed to each other, orifice axes thereof in a longitudinal direction match with each other, and orifice cross sections thereof have rectangular shapes. The first gas orifice 81 and the second gas orifice (not shown) form a groove having a rectangular cross section on an outer wall surface of a liquid orifice member 95 in which a liquid orifice 91 is formed, and a cap portion 85 as a lid is put on the groove, thereby forming the first gas orifice 81 and the second gas orifice (not shown) having the rectangular cross sections.

Gas is supplied from a gas passage portion 80. If the gas passage portion 80 is connected to a compressor (not shown) and the compressor is controlled, an injection amount and an injection speed of gas can be set. The gas passage portion 80 is in communication with both the first gas orifice 81 and the second gas orifice, and the injection amounts and the injection speeds (flow speed) of gases respectively injected from the first gas orifice 81 and the second gas orifice are set the same.

Liquid is supplied from a liquid passage portion 90. The liquid passage portion 90 is connected to a liquid supply portion (not shown), and the liquid supply portion pressurizes liquid and sends the liquid to the liquid passage portion 90. The liquid supply portion sets a liquid sending amount and a liquid sending speed of liquid. The liquid passage portion 90 is formed by a nozzle-retaining portion 99, and the gas passage portion 80 is formed by a nozzle body 89 provided on an outer wall portion of the nozzle-retaining portion 99 (this is the same in subsequent embodiments also).

As shown in FIG. 7(b), gases injected from the first gas orifice 81 and the second gas orifice form a collision wall (including collision portion) in a gas-liquid mixing area M. Liquid injected from the liquid orifice 91 is made to collide with this collision wall, thereby atomizing the liquid. In FIG. 7, the gas-liquid mixing area M is formed in the liquid orifice member 95 in a form of a pyramid which spreads out in the liquid injection direction. An atomization tip end area M1 which is adjacent to the gas-liquid mixing area M in the liquid injection direction is formed in the cap portion 85 in a form of a pyramid which spreads out larger than the gas-liquid mixing area M. According to this structure, even if an angle of the atomization spraying pattern is wide, it is possible to suppress a case where the atomized body comes into contact with a wall surface such as the atomization tip end area M1 and the atomized body grows up into a liquid drop.

Although the cap portion 85 and the liquid orifice member 95 form the first and second gas orifices in the embodiment 1, one member may form the first and second gas orifices. The cross section shapes of the first and second gas orifices are not limited to the rectangular shapes, and other polygonal shape or circular shape may be employed. The gas orifices are not limited to the two gas orifices, i.e., the first and second gas orifices, and a third gas orifice, a fourth gas orifice or more gas orifices may be formed. The shape of the gas-liquid mixing area M is not limited to the above-described shape, and a cylindrical shape, a conical shape and a polygonal pyramid shape may be employed, but it is preferable that the shape spreads out in the injection direction of the atomized body.

### Embodiment 2

A liquid atomizing device (configured as nozzle device) of this embodiment will be described with reference to FIG. 8.

According to the liquid atomizing device shown in FIG. 8, a first gas orifice 81 configuring a first gas injection portion and a second gas orifice (not shown) configuring a second gas injection portion are disposed such that the gas orifices are opposed to each other, orifice axes thereof in a longitudinal direction match with each other, and orifice cross sections thereof have rectangular shapes. The first gas orifice 81 and the second gas orifice (not shown) form a groove having a rectangular cross section on an outer wall surface of an outer member 96 which covers a liquid orifice member 95 in which a liquid orifice 91 is formed, and a cap portion 85 as a lid is put on the groove, thereby forming the first gas orifice 81 and the second gas orifice (not shown) having rectangular cross sections. A tip end of the liquid orifice 91 enters a collision wall (including collision portion) formed by collision between gases which are injected from the first gas orifice 81 and the second gas orifice (corresponding to disposition of FIG. 3(c)).

A gas passage portion 80 and a liquid passage portion 90 are the same as those of the embodiment 1, and it is possible to employ the same configurations as those of the liquid supply portion and a compressor which supplies gas.

As shown in FIG. 8(b), gases injected from the first gas orifice 81 and the second gas orifice form a collision wall (including collision portion) in a gas-liquid mixing area M. Liquid injected from the liquid orifice 91 is made to collide with this collision wall, thereby atomizing the liquid. In FIG. 8, the gas-liquid mixing area M is formed in the outer member 96 in a form of a pyramid which spreads out in the liquid injection direction. As shown in FIG. 8(b), a tip end of the liquid orifice 91 enters a collision wall (not shown) formed in the gas-liquid mixing area M. An atomization tip end area M1 which is adjacent to the gas-liquid mixing area M in the liquid injection direction is formed in the cap portion 85 in a form of a pyramid which spreads out larger than the gas-liquid mixing area M. As shown in FIG. 8(d), a tip end 95a of the liquid orifice member 95 may be tapered. By tapering the tip end 95a, gas flows (1) and (3) flow along the tapered shape as shown in FIG. 16, it is possible to prevent gases of gas flows (2) and (4) from flowing backward into the liquid orifice, liquid can be made to collide with the collision wall (including collision portion) formed by the gas flows (2) and (4) such that the liquid intersects with the collision wall at right angles, and the liquid can be miniaturized (atomized). Although gas flow (1) (or (3)) is injected from the same gas orifice as the gas flow (2) (or (4)), the gas flow (1) (or (3)) may be injected from a gas orifice which is different from that of the gas flow (2) (or (4)).

Although the cap portion 85 and the outer member 96 form the first and second gas orifices in the embodiment 2, one member may form the first and second gas orifices. One member may form the outer member 96 and the liquid orifice member 95. The cross section shapes of the first and second gas orifices are not limited to the rectangular shapes, and other polygonal shape or circular shape may be employed. The gas orifices are not limited to the two gas orifices, i.e., the first and second gas orifices, and a third gas orifice, a fourth gas orifice or more gas orifices may be formed. The shape of the gas-liquid mixing area M and the atomization tip end area M1 are not limited to the above-described shapes, and a cylindrical shape, a conical shape and a polygonal pyramid shape may be employed, but it is preferable that the shape spreads out in the injection direction of the atomized body.

### Embodiment 3

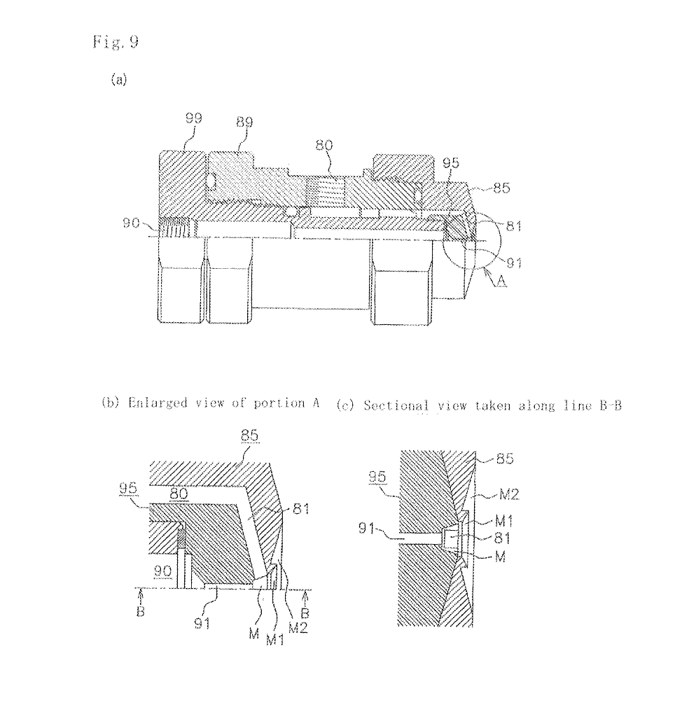

A liquid atomizing device (configured as nozzle device) of this embodiment will be described with reference to FIG. 9. According to the liquid atomizing device shown in FIG. 9, a first gas orifice 81 configuring a first gas injection portion and a second gas orifice (not shown) configuring a second gas injection portion are disposed such that a collision angle of gas becomes 150°, and orifice cross sections thereof have rectangular shapes. The first gas orifice 81 and the second gas orifice (not shown) form a groove having a rectangular cross section on an outer wall surface of a liquid orifice member 95 in which a liquid orifice 91 is formed, and a cap portion 85 as a lid is put on the groove, thereby forming the first gas orifice 81 and the second gas orifice (not shown) having rectangular cross sections.

A gas passage portion 80 and a liquid passage portion 90 are the same as those of the embodiment 1, and it is possible to employ the same configurations as those of the liquid supply portion and a compressor which supplies gas.

As shown in FIG. 9(b), gases injected from the first gas orifice 81 and the second gas orifice form a collision wall (including collision portion) in a gas-liquid mixing area M. Liquid injected from the liquid orifice 91 is made to collide with this collision wall, thereby atomizing the liquid. In FIG. 9(b), the gas-liquid mixing area M is formed in the liquid orifice member 95 in a form of a pyramid which spreads out in the liquid injection direction. An atomization tip end first area M1 which is adjacent to the gas-liquid mixing area M in the liquid injection direction is formed in the cap portion 85 in a form of a pyramid which spreads out larger than the gas-liquid mixing area M. Further, an atomization tip end second area M2 which is adjacent to this atomization tip end first area M1 in the liquid injection direction is formed in the cap portion 85 in a form of a pyramid which spreads out larger than the atomization tip end first area M1. An outlet portion of the atomization tip end first area M1 is formed into a different-level structure in which the outlet portion enters an inlet portion of the atomization tip end second area M2. By the different-level structure, even if an angle of the atomization spraying pattern is wide, it is possible to suppress a case where the atomized body comes into contact with a wall surface of the atomization tip end second area M2 and the atomized body grows up into a liquid drop.

Although the cap portion 85 and the liquid orifice member 95 form the first and second gas orifices in the embodiment 3, one member may form the first and second gas orifices. The cross section shapes of the first and second gas orifices are not limited to the rectangular shapes, and other polygonal shape or circular shape may be employed. The gas orifices are not limited to the two gas orifices, i.e., the first and second gas orifices, and a third gas orifice, a fourth gas orifice or more gas orifices may be formed. The shape of the gas-liquid mixing area M, the atomization tip end first area M1 and the atomization tip end second area M2 are not limited to the above-described shapes, and a cylindrical shape, a conical shape and a polygonal pyramid shape may be employed, but it is preferable that the shape spreads out in the injection direction of the atomized body. The collision angle α of gas is not limited to 150°, and the collision angle α can be changed within a range of 90° to 180°. The different-level structure in which the outlet portion of the atomization tip end first area M1 enters the inlet portion of the atomization tip end second area M2 is not absolutely necessary, and the different level may be omitted.

### Embodiment 4

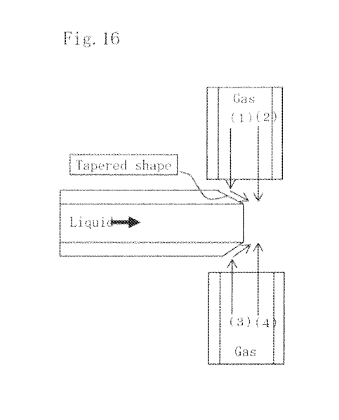

A liquid atomizing device (configured as nozzle device) of this embodiment will be described with reference to FIG. 15. According to the liquid atomizing device shown in FIG. 15, a first gas orifice 81 configuring a first gas injection portion and a second gas orifice (not shown) configuring a second gas injection portion are disposed such that a collision angle of gas becomes 150°, and orifice cross sections thereof have rectangular shapes. The first gas orifice 81 and the second gas orifice (not shown) form a groove having a rectangular cross section on an outer wall surface of a liquid orifice member 95 in which a liquid orifice 91 is formed, this groove is covered with an outer member 96 as a lid, and a cap portion 85 is provided from outside of the outer member 96. A groove having a rectangular cross section is formed in an outer wall surface of the outer member 96 such that the groove is located to form an angle of 30° with respect to a longitudinal axis of an orifice of the first gas orifice 81 and the second gas orifice (not shown), and this groove is covered, from outside, with the cap portion 85 as a lid, thereby forming a first auxiliary gas orifice 811 (configuring a first auxiliary gas injection portion) and a second auxiliary gas orifice (not shown, configuring a second auxiliary gas injection portion). The first auxiliary gas orifice 811 and the second auxiliary gas orifice are disposed at a level different from the first gas orifice and the second gas orifice in a liquid injection direction from the liquid orifice 91.

A gas passage portion 80 and a liquid passage portion 90 are the same as those of the embodiment 1, and it is possible to employ the same configurations as those of the liquid supply portion and a compressor which supplies gas. Gas from the gas passage portion 80 flows through the first gas orifice 81, the second gas orifice (not shown), the first auxiliary gas orifice 811 and the second auxiliary gas orifice (not shown).

As shown in FIG. 15(b), gases injected from the first gas orifice 81 and the second gas orifice form a collision wall (including collision portion) in a gas-liquid mixing area M. Liquid injected from the liquid orifice 91 is made to collide with this collision wall, thereby atomizing the liquid. In FIG. 15(b), the gas-liquid mixing area M is formed in the liquid orifice member 95 in a form of a pyramid which spreads out in the liquid injection direction. An auxiliary gas collision area M3 which is adjacent to the gas-liquid mixing area M in the liquid injection direction is formed in the outer member 96 in a form of a pyramid which spreads out larger than the gas-liquid mixing area M. In the auxiliary gas collision area M3, gas injected from the first auxiliary gas orifice 811 and the second auxiliary gas orifice is made to collide with an atomized body generated in the gas-liquid mixing area M, and droplet in the atomized body can suitably be miniaturized.

An atomization tip end first area M1 which is adjacent to the auxiliary gas collision area M3 in the liquid injection direction is formed in the cap portion 85 as a combination of a cylindrical portion and a pyramid which spreads out larger than the auxiliary gas collision area M3. Further, an atomization tip end second area M2 which is adjacent to this atomization tip end first area M1 in the liquid injection direction is formed in the cap portion 85 in a form of a pyramid which spreads out larger than the atomization tip end first area M1. An outlet portion of the atomization tip end first area M1 is formed into a different-level structure in which the outlet portion enters an inlet portion of the atomization tip end second area M2 like FIG. 9 of the embodiment 3.

Although the liquid orifice member 95 and the outer member 96 form the first and second gas orifices in the embodiment 4, one member may form the first and second gas orifices. Although the cap portion 85 and the outer member 96 form the first and second auxiliary gas orifices, one member may form the first and second auxiliary gas orifices. One member may form the first and second gas orifices and the first and second auxiliary gas orifices. Cross section shapes of the first and second gas orifices and the first and second auxiliary gas orifices are not limited to the rectangular shapes, and other polygonal shapes or circular shapes may be employed. The gas orifices are not limited to the two gas orifices, i.e., the first and second gas orifices, and a third gas orifice, a fourth gas orifice or more gas orifices may be formed. The auxiliary gas orifices are not limited to two auxiliary gas orifices, i.e., the first and second auxiliary gas orifices, and a third auxiliary gas orifice, a fourth auxiliary gas orifice or more auxiliary gas orifices may be formed. The shapes of the gas-liquid mixing area M, the auxiliary gas collision area M3, the atomization tip end first area M1 and the atomization tip end second area M2 are not limited to the above-described shapes, and a cylindrical shape, a conical shape and a polygonal pyramid shape may be employed, but it is preferable that the shape spreads out in the injection direction of the atomized body. The collision angle α of gas is not limited to 150°, and the collision angle α can be changed within a range of 90° to 180°. The different-level structure in which the outlet portion of the atomization tip end first area M1 enters the inlet portion of the atomization tip end second area M2 is not absolutely necessary, and the different level may be omitted.

The first and second gas orifices and the first and second auxiliary gas orifices are disposed at different levels in the liquid injection direction (they are superposed on one another straightly as viewed from front side of atomization in FIG. 15) but the invention is not limited to this disposition relation, and disposition of the first and second auxiliary gas orifices can be changed. For example, the first and second auxiliary gas orifices may be rotated a predetermined angle (e.g., 0° to 90°) with respect to the first and second gas orifices as viewed from front side of atomization to form a step. Sizes of the rectangular cross sections of the first auxiliary gas orifice 811 and the second auxiliary gas orifice may be the same as or smaller than those of the first gas orifice 81 and the second gas orifice (not shown).

### Another Embodiment

A two-fluid nozzle is assembled in a liquid injection portion, and liquid minute particle which is primary miniaturized by the two-fluid nozzle is made to collide with a collision portion or a collision wall formed by collision between gases, thereby carrying out secondary miniaturization.

(Evaluation of Atomizing Amount Characteristics)

Atomizing amount characteristics were evaluated using a liquid atomizing device of disposition configuration shown in FIG. 3(c). Gas orifice diameters φ of the first and second gas injection portions 1 and 2 were set to 0.406 mm and a gas orifice diameters φ of the liquid injection portion 6 was set to 0.25 mm. Air was used as gas, and water was used as liquid. An air amount (NL/min) and an atomizing amount (ml/min) when an air pressure of gas injection was set to a constant condition of 0.2 MPa and a water pressure (MPa) of liquid injection was changed were measured. As comparison, evaluations were conducted using a conventional internal mixture type two-fluid nozzle.

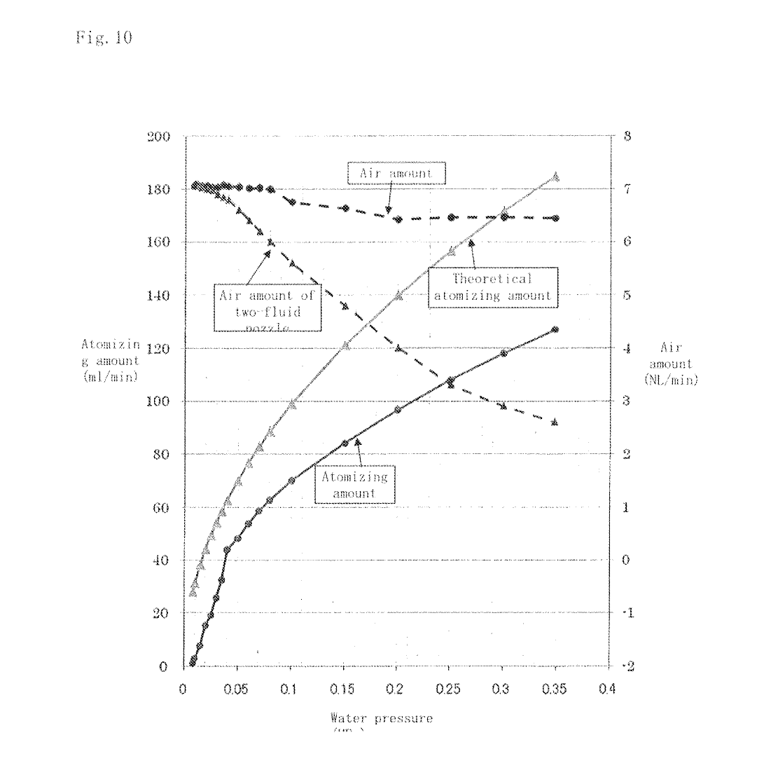

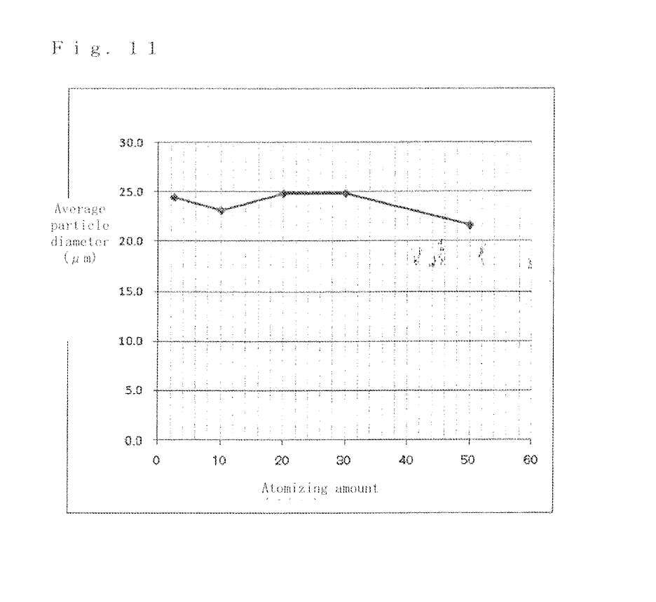

Evaluation results are shown in FIG. 10. The following facts were found from the evaluation results. In the case of a liquid atomizing device, since gas and liquid are mixed in atmosphere (outside mixing type), even if an atomizing amount is changed under a water pressure, change in an air amount is small, and it is possible to easily control the atomizing amount by a compressor having relatively low ability. Further, the liquid atomizing device can be operated under an extremely low water pressure (extremely small atomizing amount) without generating the backflow phenomenon for outside mixing. When the atomizing amount is small, a water pressure is low and a pressure loss is generated on the side of the water orifice due to resistance of the collision wall at the outlet of the water orifice. Therefore, a small atomizing amount is obtained due to this preferable influence, a ratio (turn down) of maximum atomizing amount/minimum atomizing amount becomes great and there is a possibility of zero start of the atomizing amount. On the other hand, in the case of a conventional inside mixing type two-fluid nozzle, if a water pressure is increased to increase an atomizing amount, an air amount is reduced and an air-water volume ratio is reduced and thus, a particle diameter is changed. As countermeasure against this, it is necessary to control an air pressure (air amount) in accordance with change of the atomizing amount, thereby increasing costs for improving ability of the compressor and providing a control device. Further, if the air pressure is increased, since air flows backward into the water orifice, it is difficult to widely change the atomizing amount.

### Example

Using the liquid atomizing devices (FIGS. 7 to 9) of the embodiments 1 to 3, various evaluations were conducted. Air was used as gas and water was used as liquid. The liquid orifice diameter φ is 0.4 mm. A cross section of an air orifice is rectangle (height is 0.47 mm and width is 0.6 mm). In Table 1, an air amount Qa, an atomizing amount Qw, an air-water ratio (Qa/Qw), an average particle diameter (SMD), and atomizing flow speed when an air pressure and a water pressure were changed were evaluated. The average particle diameter (SMD) was measured by a measuring device of a laser diffractometry by measuring an atomized body at a position of an atomizing distance of 300 mm. The atomizing flow speed of the atomized body was measured by an anemometer at a position of 500 mm. The conventional two-fluid nozzle is shown as a comparative example. A liquid orifice diameter φ of this two-fluid nozzle is 2.5 mm.

TABLE 1

| | | | | | | Average | |
|---|---|---|---|---|---|---|---|
| | Air | Water | | Atomizing | Gas-water | particle | Atomizing |
| | pressure | pressure | Air amount | amount | ratio | diameter | flow speed |
| | Pa (MPa) | Pw (MPa) | Qa (NL/min) | Qw (ml/min) | Qa/Qw | SMD (μm) | (m/s) |
| Embodiment 1 | 0.05 | 0.038 | 12.00 | 52.40 | 229.0 | 22.84 | 1.5 |
| (FIGS. 7) | 0.10 | 0.048 | 18.40 | 50.00 | 368.0 | 15.32 | 1.8 |
| | 0.20 | 0.135 | 25.00 | 95.90 | 260.7 | 14.06 | 2.5 |
| Embodiment 2 | 0.10 | 0.057 | 9.75 | 52.50 | 185.7 | 34.36 | 0.1 |
| (FIGS. 8) | 0.20 | 0.070 | 17.00 | 51.20 | 332.0 | 20.19 | 1.3 |
| | 0.30 | 0.103 | 25.00 | 47.70 | 524.1 | 30.17 | 2.0 |
| Embodiment 3 | 0.050 | 0.055 | 5.75 | 48.00 | 119.8 | 28.14 | 2.0 |
| (FIGS. 9) | 0.095 | 0.075 | 7.82 | 45.70 | 171.1 | 18.07 | 2.6 |
| | 0.190 | 0.130 | 15.00 | 40.40 | 371.3 | 11.77 | 3.6 |
| | 0.190 | 0.213 | 15.00 | 88.00 | 170.5 | 17.00 | 3.9 |
| Conventional | 0.2 | 0.4 | 60 | 41.6 | 1442 | 13.7 | 6.0 |
| two-fluid | | | | | | | |
| nozzle | | | | | | | |

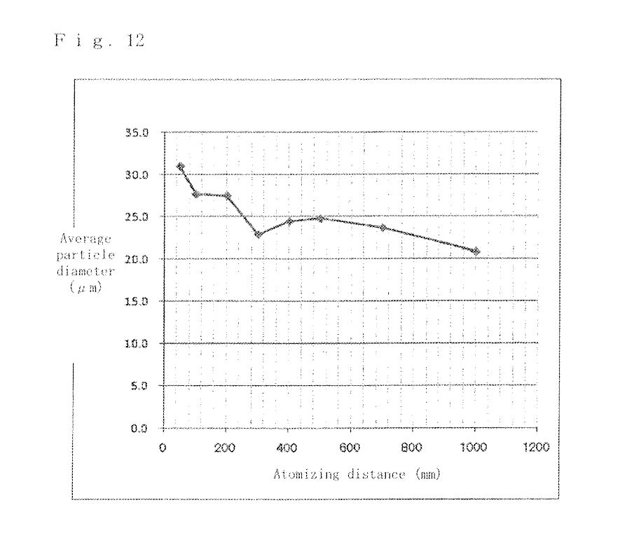

Next, a relation between the atomizing amount and the average particle diameter of the liquid atomizing device in the embodiment 1 (FIG. 7) is shown in FIG. 11. An average particle diameter of atomized bodies at a central portion of a spray width at a position of an atomizing distance of 300 mm when an air pressure was constant at 0.05 MPa and an atomizing amount was changed was measured. As a result, it was confirmed that the average particle diameter was stable even if the atomizing amount was changed to 20 times, and characteristics which were not possessed by the conventional two-fluid nozzle could be obtained.

Next, a relation between an atomizing distance and an average particle diameter of the liquid atomizing device of the embodiment 1 (FIG. 7) is shown in FIG. 12. When an air pressure was set to 0.05 MPa and a water pressure was set to 0.038 MPa as conditions of the embodiment 1 (FIG. 7), an air amount was 12.0 NL/min, an atomizing amount was 52.4 ml/min, and an air-water volume ratio was 229. It was confirmed that water drop was evaporated at close distance (short time) due to low flow speed atomizing.

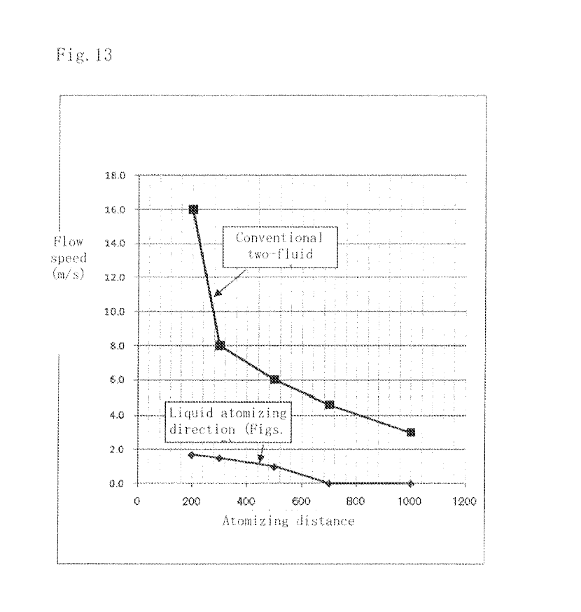

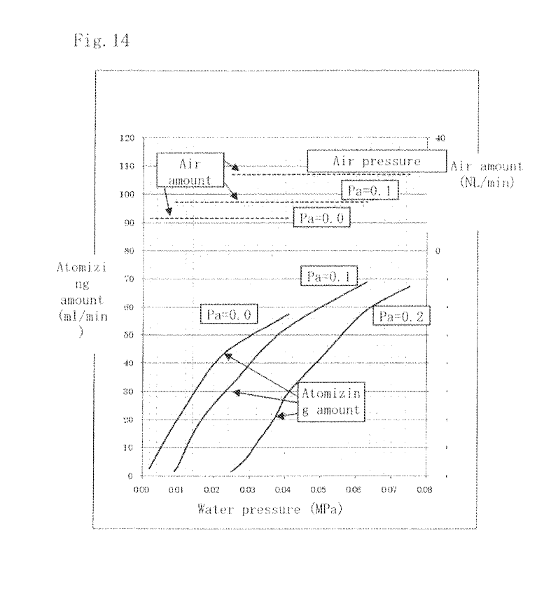

Next, results of comparison and evaluation of the conventional two-fluid nozzle and the atomizing flow speed are shown in FIG. 13. When an air pressure was set to 0.05 MPa and a water pressure was set to 0.038 MPa as conditions of the embodiment 1 (FIG. 7), an air amount was 12.0 NL/min, an atomizing amount was 52.4 ml/min, and an air-water volume ratio was 229. When an air pressure was set to 0.2 MPa and a water pressure was set to 0.04 MPa in the conventional two-fluid nozzle, an air amount was 60.0 NL/min, an atomizing amount was 41.4 ml/min, and an air-water volume ratio was 1449.3. It was confirmed that according to the liquid atomizing device of the embodiment 1, the flow speed was much slow and it was easily drifted by wind as compared with the conventional two-fluid nozzle.

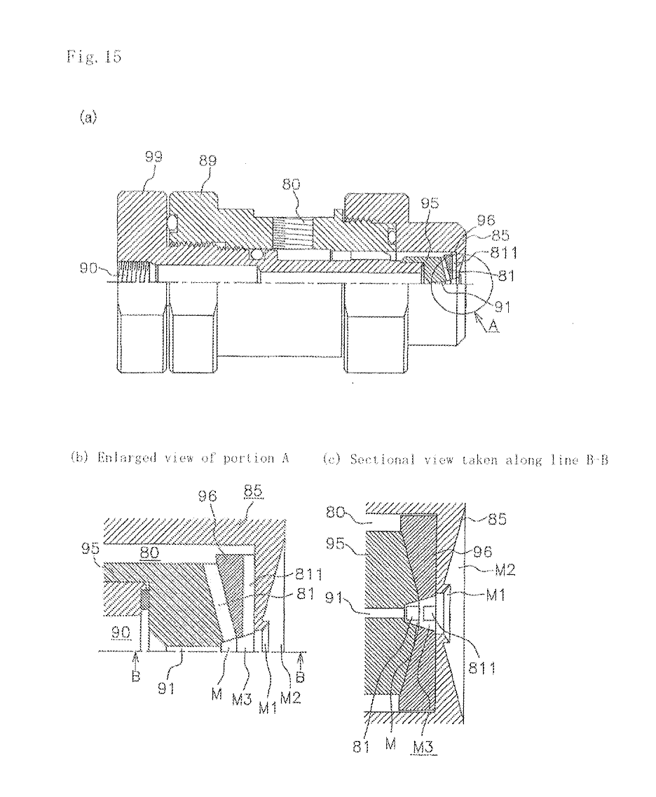

Next, a pressure (Pa) of the liquid atomizing device of the embodiment 1 (FIG. 7) and characteristics of the atomizing amount are shown in FIG. 14. It was confirmed that the atomizing amount could largely be changed with small change in a water pressure, and at the time, since the air pressure was not changed (or slightly changed), the control method could be simplified.

### DESCRIPTION OF REFERENCE SIGNS

1 first gas injection portion (first gas orifice)
2 second gas injection portion (second gas orifice)
6 liquid injection portion (liquid orifice)
62 atomized body
71, 72 restricting gas injection portion
81 first gas orifice
91 liquid orifice
100 collision portion
101 collision wall
M gas-liquid mixing area
M1 atomization tip end (first) area
M2 atomization tip end second area
M3 auxiliary gas mixing area

1. A liquid atomizing device comprising:
a first gas injection portion and a second gas injection portion from which gases are injected, wherein an angle range of 45° to 220° is formed between an injection direction axis of the first gas injection portion and an injection direction axis of the second gas injection portion;
a liquid injection portion from which liquid is injected; and
a collision portion formed by making gases injected from the first and second gas injection portions collide with each other at a location forward of a tip end of the liquid injection portion, wherein the collision portion or a portion including the collision portion and liquid injected from the liquid injection portion are made to collide with each other to atomize the liquid.

2. The liquid atomizing device according to claim 1, wherein an angle range of 90° to 180° is formed between the injection direction axis of the first gas injection portion and the injection direction axis of the second gas injection portion.

3. The liquid atomizing device according to claim 1, wherein an injection direction of the first gas injection portion and an injection direction of the second gas injection portion are opposed to each other, and an injection direction axis of the first gas injection portion and an injection direction axis of the second gas injection portion match with each other.

4. The liquid atomizing device according to claim 1, wherein liquid is injected from the liquid injection portion such that an injection direction axis of the liquid intersects with the collision portion at right angles.

5. The liquid atomizing device according to claim 1, further comprising an auxiliary gas injection portion disposed at a level different from the gas injection portion toward an injection direction of liquid from the liquid injection portion.

6. The liquid atomizing device according to claim 1, wherein the liquid is of continuous flow, intermittent flow or impulse flow.

7. The liquid atomizing device according to claim 1, wherein the liquid is miniaturized liquid.

8. The liquid atomizing device according to claim 1, further comprising a restricting gas injection portion which injects gas for deforming a pattern shape of an atomization pattern of an atomized body which is formed by making the portion including the collision portion and liquid injected from the liquid injection portion collide with each other to atomize the liquid.

9. A liquid atomizing method, comprising:
injecting a liquid;
controlling two gases to collide with each other in an angle range of a collision angle of 45° to 220° at a location forward of an injection position where the liquid is injected, thereby forming a collision portion; and
causing the collision portion or a portion including the collision portion to collide with the injected liquid to atomize the liquid.
